(19) United States
(12) Patent Application Publication
(10) Pub. No.: US 2017/0181098 A1
(43) Pub. Date: Jun. 22, 2017

(54) SENSOR NODE, SENSOR NETWORK SYSTEM, AND MONITORING METHOD

(71) Applicant: ROHM CO., LTD., Kyoto (JP)

(72) Inventor: Toshikuni SHINOHARA, Kyoto (JP)

(21) Appl. No.: 15/384,982

(22) Filed: Dec. 20, 2016

(30) Foreign Application Priority Data
Dec. 22, 2015 (JP) 2015-250056

(51) Int. Cl. H04W 52/02

(52) U.S. Cl. CPC H04W 52/0261; H04W 4/008

(57) ABSTRACT

A sensor node for use in a wireless sensor network, includes: a sensor element configured to detect a physical quantity in a time-series manner; a data processing part configured to Fourier-transform time-series data detected by the sensor element and extract a plurality of feature quantities representing features of an obtained spectrum; and a communication part configured to wirelessly transmit only the plurality of feature quantities, rather than transmitting the time-series data.

### CROSS-REFERENCE TO RELATED APPLICATION

This application is based upon and claims the benefit of priority from Japanese Patent Application No. 2015-250056, filed on Dec. 22, 2015, the entire contents of which are incorporated herein by reference.

### TECHNICAL FIELD

The present disclosure relates to a sensor network system, and more particularly, to a sensor node for collecting data from a sensor network. Further, the present disclosure relates to a method of monitoring a monitoring target using a sensor network system.

### BACKGROUND

A wireless sensor network (WSN) (hereinafter, also referred to simply as a “sensor network”) is a communication network including a wireless terminal (which is referred to as a “sensor node”) having a plurality of sensors and is used to collect information from each sensor node. In the WSN, a communication scheme such as ZigBee®, EnOcean®, Wi-SUN®, or Bluetooth® low energy (BLE) is used.

Data transmitted from each sensor node is relayed by a relay and then transmitted to a higher calculator such as a server or the like. The higher calculator executes various processing based on data received from a plurality of sensor nodes.

In the sensor network, it is preferred that each sensor node can operate without requiring an external power source. Thus, generally, each sensor node is configured to operate intermittently to consume less power. The intermittent operation refers to driving a peripheral device such as a sensor and a communication device only when a task is executed.

Meanwhile, in order to detect abnormality of a monitoring target, a plurality or sensors are required to operate constantly. In a situation where the plurality of sensors constantly operate in this way, a problem of securing a communication power in use, a problem of securing a radio band to transmit a huge amount of data, and the like may arise. Thus, a reduction in an amount of transmission data is an essential task.

In the related art, a sensor network system is provided which is also capable of securing a communication band of a wireless network, while having a plurality of sensor nodes for measuring data having a high sampling rate. Specifically, the sensor node calculates a feature quantity from an observation value obtained during a predetermined period and determines whether the feature quantity exceeds a predetermined threshold value or not. The sensor node transmits the observation value obtained during the predetermined period to a server only when the feature quantity thus calculated exceeds the predetermined threshold value. Here, the feature quantity refers to a quantity obtained by digitizing features of the observation value, and also to a quantity that may be used as a standard of judgment. Single data or a plurality of data having a data amount smaller than a plurality of observation values are calculated using the plurality of observation values and used as feature quantities.

Although not aiming at securing a communication band of a wireless sensor network, a moving object warning system which is capable of simply identifying a type of a moving object that approaches and warning is disclosed in the related art. A moving object determining means converts vibration or noise of a moving object detected by a sensor into a frequency spectrum, and extracts a dominant frequency from the converted frequency spectrum. Further, the moving object determining means compares the extracted dominant frequency with each reference frequency of a reference frequency group associated with a type of the moving object to determine the type of the moving object.

In the case of the sensor network system described above, if the feature quantity frequently exceeds a predetermined threshold value, a problem may arise in that an amount of transmission data is hardly reduced and is substantially not different from that of a case where original time-series data is transmitted as it is. In addition, since not reacting to abnormality other than a transmission determination in a sensor part, the above-described technique is difficult to use, for example, in prediction of a fault due to an aging degradation, preventive maintenance, or the like.

### SUMMARY

The present disclosure provides some embodiments of a technique of further reducing an amount of data to be transmitted from a sensor node in a wireless sensor network, compared with the techniques in the related art. Other problems and novel features will become apparent from the description of the present disclosure and the accompanying drawings.

According to one embodiment of the present disclosure, there is provided a sensor node for use in a wireless sensor network, including: a sensor element configured to detect a physical quantity in a time-series manner; a data processing part; and a communication part. The data processing part is configured to Fourier-transform time-series data detected by the sensor element and extract a plurality of feature quantities representing features of an obtained spectrum. The communication part is configured to wirelessly transmit only the plurality of feature quantities, rather than transmitting the time-series data.

The sensor node may be configured to operate only with an internal power source, without receiving power from outside.

According to another embodiment of the present disclosure, there is provided a sensor network system, including: a plurality of sensor nodes; and a gateway device configured to wirelessly communicate with each of the sensor nodes.

According to still another embodiment of the present disclosure, there is provided a monitoring method, including: detecting a physical quantity of a monitoring target in a time-series manner, by each of a plurality of sensor nodes that constitute a wireless sensor network system; Fourier-transforming time-series data detected by each of the sensor nodes. Further, the monitoring method includes: extracting a plurality of feature quantities representing features of a spectrum obtained by Fourier transform, by each of the sensor nodes; wirelessly transmitting the plurality of feature quantities from each of the sensor nodes; and determining abnormality of the monitoring target based on a change in the plurality of feature quantities received from each of the sensor nodes over time, by a higher calculator.

### BRIEF DESCRIPTION OF THE DRAWINGS

FIG. 1 is a block diagram illustrating a schematic configuration of a wireless sensor network system.

FIG. 2 is a block diagram illustrating an example of a hardware configuration of a sensor device of FIG. 1.

FIG. 3 is a flowchart illustrating a procedure of data processing by the sensor device of FIG. 2.

FIG. 4 is a flowchart illustrating a processing procedure by a higher calculator of FIG. 1.

FIG. 5 is a view illustrating an example of a power spectrum.

### DETAILED DESCRIPTION

Embodiments of the present disclosure will now be described with reference to the drawings. Further, the same reference numerals are used for the same or corresponding parts and a description thereof will be not repeated.

### Configuration of Sensor Network

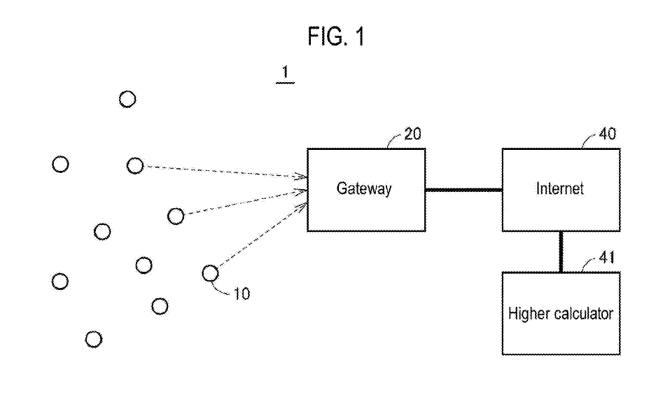

FIG. 1 is a block diagram illustrating a schematic configuration of a wireless sensor network system. The wireless sensor network system (also referred to as a “sensor network system” herein) 1 includes a plurality of sensor devices 10 and a gateway device 20. The sensor device 10 is also referred to as a sensor node, and the gateway device 20 is also referred to as a control node.

Each of the sensor devices 10 includes a sensor element for detecting an ambient physical quantity or the like in a time-series manner. Each of the sensor devices 10 is configured as a wireless communication terminal for transmitting information based on time-series data detected by the sensor element. A communication scheme such as ZigBee®, EnOcean®, Wi-SUN®, or BLE (Bluetooth® Low Energy) is used for communication between each of the sensor devices 10 and the gateway device 20.

In the sensor network system, each of the sensor devices 10 transmits a plurality of feature quantities calculated based on the time-series data, rather than transmitting the time-series data detected by the sensor element as it is, in order to reduce a communication amount. A specific method of calculating the plurality of feature quantities will be described later.

Each of the sensor devices 10 may have a relay routing function to transmit transmission data from another sensor device 10 to the gateway device 20. Further, each of the sensor devices 10 may have an ad-hoc function to directly communicate with each other. In addition, the plurality of sensor devices 10 that constitute a sensor network may constitute a tree network or a mesh network.

The gateway device 20 receives data transmitted from each of the plurality of sensor devices 10 and transmits the received data to a higher calculator (a personal computer, a server, a cloud, etc.) 41 via a network 40 such as the Internet. Further, the gateway device 20 receives a control command, setting information, and the like regarding each sensor device 10 from the higher calculator 41 via the network 40. The gateway device 20 may also have a function of storing and/or calculating the received data, as well as simply relaying the data transmitted from each sensor device 10. A wired local area network (LAN), Wi-Fi®, Bluetooth®, or the like is used for communication between the gateway device 20 and the higher network 40.

### Hardware Configuration of Sensor Device

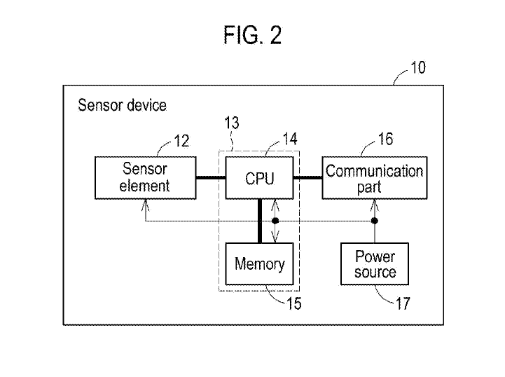

FIG. 2 is a block diagram illustrating an example of a hardware configuration of the sensor device of FIG. 1. Referring to FIG. 2, the sensor device 10 includes a sensor element 12, a central processing unit (CPU) 14, a memory 15, a communication part 16, and a power source 17. A micro control unit (MCU) 13 may also be configured to include the CPU 14, the memory 15, and other peripheral devices (not shown).

The sensor element 12 detects a physical quantity of a monitoring target in a time-series manner. The type of the sensor element 12 is not particularly limited and the present disclosure is applicable to any sensor element as long as it detects some physical quantities. For example, various sensors such as a magnetic sensor, an electric field sensor, a current sensor, a voltage sensor, a pressure sensor, a flow sensor, a temperature sensor, an illumination sensor, and a humidity sensor, in addition to an accelerometer, a gyro sensor, a sound sensor (microphone, etc.), may be used as the sensor element 12. Further, the present disclosure is appropriately applied to an application in which the sensor element should not be operated intermittently but constantly operated, and a detection result of the sensor element should be transmitted with high frequency. In addition, in FIG. 2, only one sensor element 12 is illustrated but a plurality of sensor elements may be installed in the sensor device 10.

A physical quantity detected in a time-series manner by the sensor element 12 (hereinafter, referred to as “time-series data”) is temporarily stored in the memory 15. In a case where the sensor element 12 is configured to output an analog signal, the output signal from the sensor element 12 is converted into digital data by an analog-to-digital converter (ADC) (not shown) which performs filtering, and then stored in the memory 15.

The CPU 14 serves as a data processing part for performing calculation processing using the time-series data detected by the sensor element 12 and stored in the memory 15. Specifically, the CPU 14 performs Fourier transform on the time-series data detected by the sensor element 12 and calculates a plurality of feature quantities that represent features of an obtained Fourier spectrum. The calculated feature quantities are temporarily stored in the memory 15. A specific method of calculating the feature quantities will be described later.

The communication part 16 wirelessly transmits the plurality of feature quantities calculated by the CPU 14 to the gateway device 20. For the wireless communication, a communication scheme such as the aforementioned ZigBee® is used. The gateway device 20 transmits the plurality of feature quantities received from the sensor device 10 to the higher calculator 41 via the Internet 40. For example, the higher calculator 41 detects whether the monitoring target is abnormal, based on the plurality of received feature quantities.

The power source 17 supplies a driving voltage to each of the elements 12, 14, 15, and 16 that constitute the sensor device 10. The sensor device 10 may be configured to operate only with the internal power source 17, without receiving power supply from the outside. Thus, for example, the power source 17 is configured to include a solar battery and a storage battery. In this case, the storage battery is charged by an electric power generated by the solar battery and each of the elements 12, 14, 15, and 16 of the sensor device 10 is driven by an output voltage from the storage battery.

### Procedure of Data Processing

As described above, in the sensor network system 1, each sensor device 10 extracts a plurality of feature quantities based on a waveform in a frequency domain obtained by performing Fourier transform on the detected time-series data. Hereinafter, a procedure of data processing will be described, and a specific example of a feature quantity will be then described.

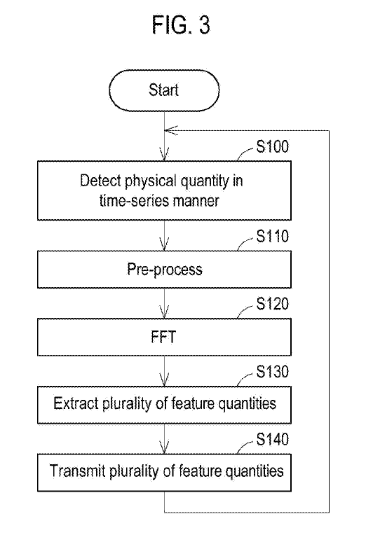

FIG. 3 is a flow chart illustrating a procedure of data processing by the sensor device of FIG. 2. Referring to FIGS. 2 and 3, first, a physical quantity of a monitoring target is detected by the sensor element 12 in a time-series manner (step S100). The CPU 14 temporarily stores the time-series data detected by the sensor element 12 in the memory 15.

Next, the CPU 14 performs pre-processing on the time-series data (step S110) and subsequently performs Fourier transform thereon (step S120). For example, a fast Fourier transform (FFT) is used as the Fourier transform.

Specifically, the pre-processing includes window processing. The window processing is processing of multiplying the time-series data by a window function in order to cut out the time-series data to be subjected to FFT. As the window function, for example, a rectangular window, a hanning window, a hamming window, a Blackman window, or the like is used. A target section of FFT cut out by the window processing is generally referred to as a “frame”. In addition to the pre-processing, low pass or band pass by a digital filter and frequency domain emphasis using a pre-emphasis filter may also be performed.

By shifting a position of the frame, the CPU 14 cuts out the time-series data and performs FFT thereon. A Fourier spectrum, which is a result of FFT, includes an amplitude spectrum and a phase spectrum. Further, a power spectrum may be calculated.

Subsequently, the CPU 14 obtains a plurality of feature quantities representing features of a spectrum obtained by FFT for each frame (step S130). A specific example of the feature quantity will be described later. In order to reduce a data amount, the CPU 14 does not transmit the time-series data itself but transmits only the plurality of feature quantities calculated from the time-series data to the higher calculator 41 via the network 40. Thereafter, the aforementioned procedure is repeated.

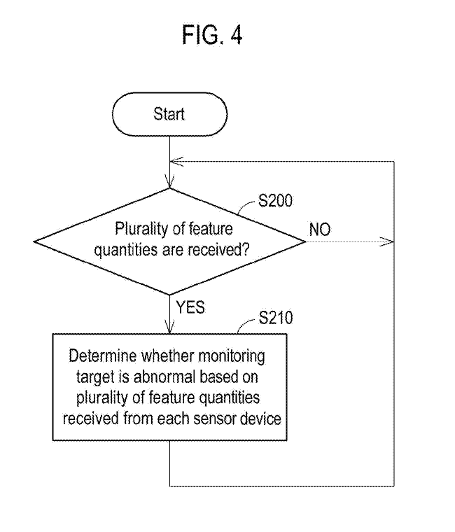

FIG. 4 is a flowchart illustrating a processing procedure by the higher calculator of FIG. 1. Referring to FIGS. 1 and 4, the higher calculator 41 is configured to communicate with the plurality of sensor devices 10 through the gateway 20 to receive output data from each sensor device 10. When data (a plurality of feature quantities) is received from any one sensor device 10 (YES in step S200), the higher calculator 41 stores the plurality of received feature quantities in the memory. Further, the higher calculator 41 monitors a monitoring target based on a change in the plurality of feature quantities received from each of the plurality of sensor devices 10 over time (for example, the higher calculator 41 determines whether the monitoring target is normal).

### Specific Example of Feature Quantity

A specific example of a feature quantity of a Fourier spectrum will now be described.

### (1) One of Amplitude and Phase

A result of Fourier transform may be obtained as a complex, but a data amount of time-series data of, for example, about 16 kB, may be approximately halved using only any one of an amplitude and a phase as a feature quantity. In the case of detecting abnormality, since phase information is not used in many cases, an amplitude or a power value is normally used as a feature quantity. Further, in the case of performing envelope detection of a spectrum in order to obtain a higher compression rate or in order to use in a spectrum analysis or the like, a linear predictive coding (LPC) analysis or cepstrum analysis, or low pass filter (LPF) processing in a frequency space is performed. In the case of transmitting spectrum envelop information, an LPC coefficient that can be obtained by linear prediction or a low-order component of cepstrum is used as a feature quantity. In the case of the LPC coefficient, amplitude sketch information obtained by compressing a data amount (for example, up to 32 order) to be transmitted to about 1/125 of the data amount may be transmitted, and in the case of cepstrum low-order component, amplitude sketch information obtained by compressing a data amount (for example, up to 80 order) to be transmitted to about 1/50 of the data amount may be transmitted.

(2) Dominant Frequency and/or Peak Value

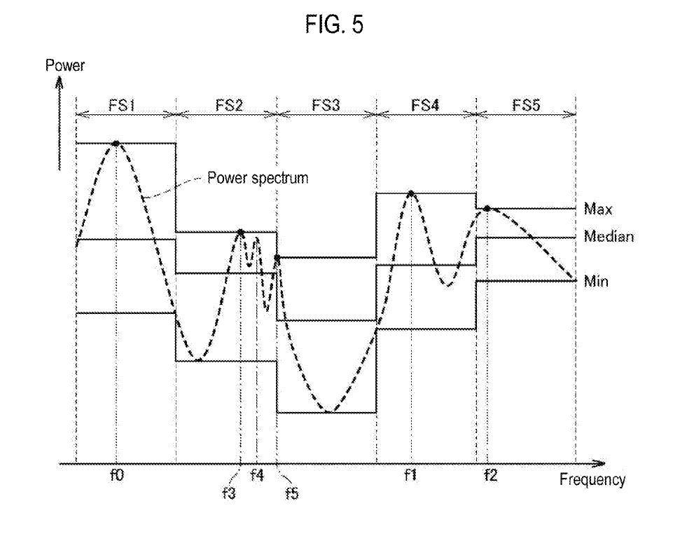

FIG. 5 is a view illustrating an example of a power spectrum. Here, an amplitude spectrum may also be used instead of the power spectrum. A feature of a shape of such a spectrum may be used as a feature quantity.

Specifically, in the power spectrum of FIG. 5, six local peaks (maximum points) are illustrated. Frequencies giving these peak values are referred to as dominant frequencies f0 to f5. Here, the orders are given to the dominant frequencies in order, starting from the highest peak value corresponding thereto. The dominant frequency and/or peak value up to a predetermined order (about from 10^{th} to 20^{th} orders) including a 0^{th} dominant frequency f0 may be used as a feature quantity.

For example, when a dominant frequency from 0^{th} to 20^{th} orders is used as a feature quantity, a data amount of 16 kB time-series data may be compressed to about 1/200 of the data amount. When both a dominant frequency from 0^{th} to 20^{th} orders and a peak value corresponding thereto are used as a feature quantity, a data amount may be compressed to about 1/100 of the data amount.

### (3) Statistic of Each Frequency Section

A frequency space may be divided at equal intervals or a logarithmic space of a frequency may be divided at equal intervals to generate a plurality of frequency sections, and a statistic amount of each of the generated frequency sections may be used as a feature quantity. For example, in the case of FIG. 5, the frequency space is divided into a plurality of sections FS1 to FS5 at equal intervals, and a maximum value Max, a minimum value Min, and a median value Median are extracted as feature quantities of each of the frequency sections. An average may be used instead of the median value. Normally, an arithmetic average is used as an average value, but in a case where the logarithm is appropriate for expressing an amplitude of a signal, a geometric mean may also be used as the average. Further, in this case, a frequency sequence corresponding to the maximum value, the minimum value, and the median value of each frequency section may also be used as a feature quantity, and the maximum value, the minimum value, the median value, and the frequency corresponding to each of the values may also be used as a feature quantity. In addition, a calculation value of a multi-band pass filter obtained by dividing a frequency space at equal intervals may also be used as a calculation that can obtain the same result. Further, a coefficient sequence based on 1/n octave analysis (multi-band pass at equal intervals in a logarithmic space) obtained by equally dividing a frequency space may be used.

For example, in a case where, instead of 16 kB time-series data, a frequency space is divided into 100 sections and a statistic amount of each section is transmitted as a feature quantity, a data amount to be transmitted may be compressed to about 1/40 of the data amount. Similarly, in a case where a frequency space is divided into 25 sections and a statistical amount of each section is transmitted as a feature quantity, a data amount to be transmitted may be compressed to about 1/160 of the data amount. In this manner, a data compression rate is in inverse proportion to the number of divided sections.

### (4) Mel-Frequency Cepstrum Coefficient Sequence

In the case of voice data or the like, a Mel-frequency cepstrum coefficients (MFCC) sequence may be extracted as a feature quantity. The MFCC is effective when analysis is performed on time-series data to match human's sensation (in the case of having importance on low frequency vibration).

In calculating an MFCC, data is compressed by multiplying power spectrum data or amplitude spectrum data by Mel-filter bank. The Mel-filter bank is an array of band pass filters and includes about 20 divided filters on a frequency axis. Frequency widths of the filters are different and dense like low frequency (narrow in frequency width) or coarse like high frequency (wide in frequency width) according to a psychological scale of auditory property. Spectrum data compressed by multiplication of the Mel-filter bank is logarithmically processed and subsequently discrete-cosine-transformed. A low-order component of cepstrum obtained through the discrete cosine transform is an MFCC.

Like the case of a voice analysis, when up to 12^{th} coefficients as MFCC are calculated, a data amount may be compressed to about 1/340 of the data amount, compared with the original time-series data.

As stated above, in the related art, when a feature quantity of time-series data frequently exceeds a threshold value, for example, when monitoring motor vibration or the like where a waveform of a basic frequency is continuously repeated, a transmission data amount is almost equal to that of a case where the original time-series data is transmitted as it is. In the case of the sensor network of the present embodiment, since the data amount can be compressed to about 1 to 2 digits, compared with the original time-series data, even in a normal state, it is possible to significantly reduce a communication burden, while maintaining features of a signal. Further, a transmitted feature quantity is a feature quantity allowing for detection of an abnormal tendency or the like, and an analysis of a variation in/shift of a specific dominant frequency, occurrence of a new dominant frequency, a variation in a spectrum sketch, or the like can be continuously performed in a higher side which has a large memory area and can perform a high rate/high functional computation, comparative computation with other part or a homogeneous device, and the like, and can be used for predicting a fault, preventive maintenance, and the like.

In addition, in the related art, in order to determine a type (a large vehicle, a small vehicle, a two-wheeled vehicle) of a moving object (vehicle) that approaches, only a basic frequency when vibration or noise of the moving object is Fourier-transformed is used. Determining a type of a vehicle by the basic frequency is substantially the same as determining a vehicle by its weight, and fine features of each vehicle type are disregarded. In contrast, in the embodiments of the present disclosure, by using a plurality of feature quantities, for example, a plurality of resonance frequencies (a dominant frequency from a basic order to a higher order) and trend information of a spectrum, it is possible to further specifically analyze a signal.

According to some embodiments of the present disclosure, each sensor node is configured to extract a plurality of feature quantities based on a spectrum obtained by Fourier-transforming the original time-series data, and wirelessly transmit the plurality of feature quantities. Thus, it is possible to further reduce a data amount transmitted from each sensor node, compared with the techniques in the related art. In this manner, since the transmission data amount is reduced, communication power can also reduced. Thus, each sensor node may be operated only with an internal power source even when it is constantly operated.

While certain embodiments have been described, these embodiments have been presented by way of example only, and are not intended to limit the scope of the disclosures. Indeed, the novel methods and apparatuses described herein may be embodied in a variety of other forms; furthermore, various omissions, substitutions and changes in the form of the embodiments described herein may be made without departing from the spirit of the disclosures. The accompanying claims and their equivalents are intended to cover such forms or modifications as would fall within the scope and spirit of the disclosures.

What is claimed is:

1. A sensor node for use in a wireless sensor network, comprising:
a sensor element configured to detect a physical quantity in a time-series manner;
a data processing part configured to Fourier-transform time-series data detected by the sensor element and extract a plurality of feature quantities representing features of an obtained spectrum; and
a communication part configured to wirelessly transmit only the plurality of feature quantities, rather than transmitting the time-series data.

2. The sensor node of claim 1, wherein the sensor node is configured to operate only with an internal power source, without receiving power from outside.

3. A sensor network system, comprising:
a plurality of the sensor nodes of claim 1; and
a gateway device configured to wirelessly communicate with each of the sensor nodes.

4. A monitoring method, comprising:
detecting a physical quantity of a monitoring target in a time-series manner, by each of a plurality of sensor nodes that constitute a wireless sensor network system;
Fourier-transforming time-series data detected, by each of the sensor nodes;
extracting a plurality of feature quantities representing features of a spectrum obtained by Fourier transform, by each of the sensor nodes;
wirelessly transmitting the plurality of feature quantities from each of the sensor nodes; and
determining abnormality of the monitoring target based on a change in the plurality of feature quantities received from each of the sensor nodes over time, by a higher calculator.
